(19) United States
(12) Patent Application Publication
(10) Pub. No.: US 2019/0323609 A1
(43) Pub. Date: Oct. 24, 2019

(54) SEALING MEMBER AND METHOD OF MANUFACTURING THE SAME

(71) Applicant: JTEKT CORPORATION, Osaka (JP)

(72) Inventor: Yohei SHIMIZU, Kashiwara-shi (JP)

(73) Assignee: JTEKT CORPORATION, Osaka (JP)

(21) Appl. No.: 16/383,152

(22) Filed: Apr. 12, 2019

(30) Foreign Application Priority Data
Apr. 18, 2018 (JP) 2018-079870

(51) Int. Cl. F16J 15/3208

(52) U.S. Cl. CPC F16J 15/3208

(57) ABSTRACT

A sealing member includes an annular core metal and an annular seal body fixed to the core metal and having a lip portion. The seal body is made of a crosslinked material of a fluororubber composition that contains uncrosslinked fluororubber, a peroxide crosslinking agent, and an acid acceptor. The crosslinked material of the fluororubber composition contains 1 to 5 parts by weight of the acid acceptor with respect to 100 parts by weight of the uncrosslinked fluororubber. The seal body is fixed to the core metal via an adhesive layer provided on a surface of the core metal.

### INCORPORATION BY REFERENCE

The disclosure of Japanese Patent Application No. 2018-079870 filed on Apr. 18, 2018 including the specification, drawings and abstract, is incorporated herein by reference in its entirety.

### BACKGROUND OF THE INVENTION

### 1. Field of the Invention

The present invention relates to a sealing member and a method of manufacturing the same.

### 2. Description of the Related Art

In a steel rolling device, a plurality of rolling mills are disposed along the direction of conveyance of a member to be rolled, and each of the rolling mills includes a plurality of rollers that hold the member to be rolled from both sides. The rollers are supported by a rolling bearing device on both sides in the axial direction. The rolling bearing device is provided with a sealing member for the purpose of preventing entry of cooling water into the bearing etc. (see FIG. 1 of Japanese Patent Application Publication No. 2016-161082 (JP 2016-161082 A)). The sealing member described in JP 1016-161082 A includes an annular core metal, a seal member fixed to the core metal, and an annular spring ring. The sealing member is configured such that a lip portion of the seal member makes sliding contact with the outer peripheral surface of an inner ring.

In recent years, the rolling speed of rolling devices has become higher, and therefore the rotational speed of rollers of rolling mills has become higher. In this case, the rotational speed of the rolling bearing device which supports the rollers also becomes higher. In the sealing device of the rolling bearing device, a large amount of heat is generated by sliding at a portion of contact between the lip portion of the seal member and the outer peripheral surface of the inner ring. Therefore, JP 2016-161082 A proposes use of fluororubber with high beat resistance as the material of the seal member,

In general, the fluororubber has high heat resistance. Therefore, it is often proposed that the fluororubber should be adopted as the material of the seal member for sealing members that require beat resistance. Meanwhile, the bearing device for roll necks of the rolling mills is used with the bearing filled with grease. In this event, grease (e.g. Palmax RBG (manufactured by Kyodo Yitshi Co., Ltd.)) that contains a thickener containing amine is occasionally used as grease that is suitable for use under high-temperature and high-rotation conditions. In the case where general-purpose fluororubber (e.g. a polyol crosslinked material of binary fluororubber (a vinylidene fluoride/hexafluoropropene copolymer)) is used as the material of the seal member in the sealing member, a defluoridation reaction in which HF departs at a high temperature tends to progress upon contact with amine, although the fluororubber has high heat resistance. As a result, a portion of the fluororubber subjected to the defluoridation reaction is hardened. Therefore, in the case where the sealing member including the seal member which is made of the general-purpose fluororubber discussed above is used as the sealing member for the bearing device for roll necks of the rolling mills, the lip portion of the seal member, which tends to contact the grease, may be solidified at an early stage because of the progress of the defluoridation reaction. Therefore, the seal performance of the sealing member may be impaired in a short time.

Thus, in order to suppress the progress of the defluoridation reaction even when the seal member contacts amine at a high temperature, it is considered to use peroxide crosslinked fluororubber as the material of the seal member. In this case, the progress of the defluoridation reaction is suppressed. However, the peroxide crosslinked fluororubber has low adhesion to a core metal made of cold rolled carbon steel (SPCC) or the like compared to the polyol crosslinked fluororubber. Therefore, it is difficult to secure sufficient adhesion between the core metal and the seal member in the case where the peroxide crosslinked fluororubber is adopted as the material of the seal member.

### SUMMARY OF THE INVENTION

It is an object of the present invention to provide a sealing member in which sufficient adhesion between a core metal and a seal member is secured while adopting peroxide crosslinked fluororubber as the material of the seal member.

An aspect of the present invention provides a sealing member including: an annular core metal; and an annular seal body fixed to the core metal and having a lip portion. The seal body is made of a crosslinked material of a fluororubber composition that contains uncrosslinked fluororubber, a peroxide crosslinking agent, and an acid acceptor, the crosslinked material of the fluororubber composition containing 1 to 5 parts by weight of the acid acceptor with respect to 100 parts by weight of the uncrosslinked fluororubber; and the seal body is fixed to the core metal via an adhesive layer provided on a surface of the core metal.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view illustrating a rolling bearing device that includes sealing members according to an embodiment of the present invention;

FIG. 2 is an enlarged sectional view illustrating the sealing member illustrated in FIG. 1;

FIG. 3 illustrates a method of evaluating the adhesion of a test piece;

FIG. 4 is a graph indicating the results of evaluation of the adhesion of test pieces; and

FIG. 5 is a photograph illustrating the state of a test piece after evaluation.

### DETAILED DESCRIPTION OF EMBODIMENTS

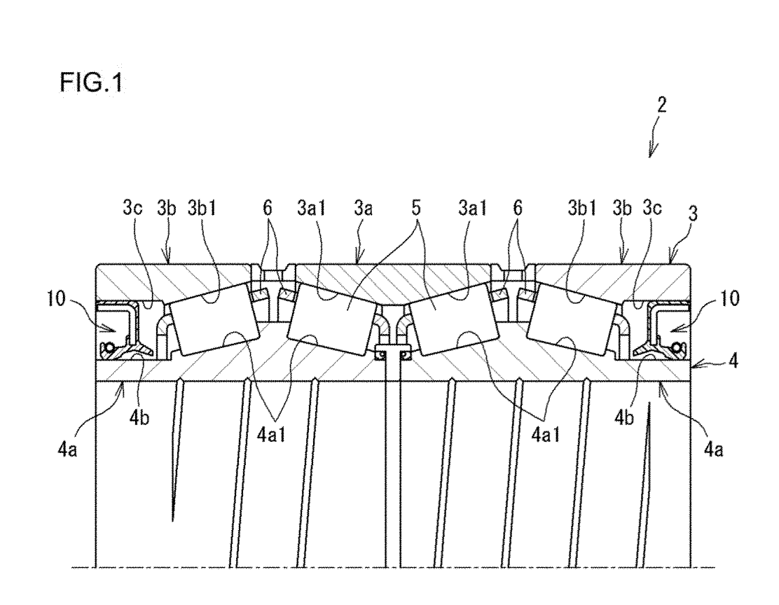

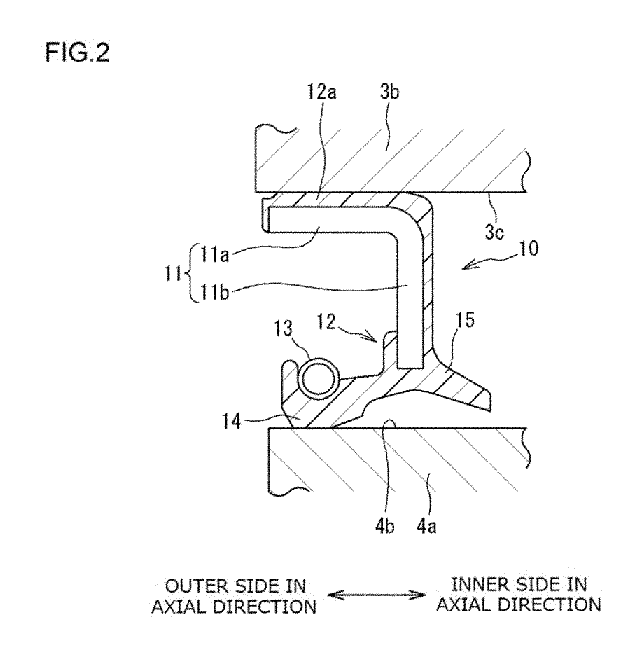

An embodiment of the present invention will be described below with reference to the drawings. FIG. 1 is a sectional view illustrating the configuration of a bearing device 2 that includes sealing members 10 according to an embodiment of the present invention. FIG. 2 is an enlarged sectional view illustrating the sealing member 10 illustrated in FIG. 1. The bearing device 2 is a rolling bearing device provided at roll necks (not illustrated) at both ends of a roller of a rolling mill to rotatably support the roller. The bearing device 2 includes an outer ring 3, an inner ring 4, tapered rollers 5 that serve as rolling elements, a cage 6, and the sealing members 10 which serve as bearing seals.

The outer ring 3 is fitted into a housing (not illustrated), which is provided to the rolling mill, to be fixed. The outer ring 3 is composed of a first outer ring member 3a in a cylindrical shape, and a pair of second outer ring members 3b in a cylindrical shape. The first outer ring member 3a is disposed at the middle of the bearing device 2 in the axial direction. The second outer ring members 3b are disposed on both sides of the first outer ring member 3a in the axial direction. The outer ring 3 is constituted by combining the first outer ring member 3a and the pair of second outer ring members 3b in the axial direction. A pair of outer ring raceway surfaces 3a1, on which the plurality of tapered rollers 5 roll, are formed on the inner peripheral surface of the first outer ring member 3a. Outer ring raceway surfaces on which the plurality of tapered rollers 5 roll, are formed on the respective inner peripheral surfaces of the pair of second outer ring members 3b.

The inner ring 4 is disposed concentrically with the outer ring 3 on the inner peripheral side of the outer ring 3. The inner ring 4 is constituted by combining a pair of inner ring members 4a in a cylindrical shape in the axial direction. A pair of inner ring raceway surfaces 4a1, on which the plurality of tapered rollers 5 roll, are formed on the outer peripheral surface of each of the inner ring members 4a. A roll neck of a roller of a rolling mill is inserted into the inner periphery of the inner ring 4 to be fixed. This allows the inner ring 4 to rotate together with the roller of the rolling mill.

The pair of outer ring raceway surfaces 3a1 which are formed on the first outer ring member 3a face the inner ring raceway surfaces 4a I which are formed on the inner side of the inner ring members 4a in the axial direction. Meanwhile, the outer ring raceway surfaces 3b1 which are formed on the second outer ring members 3b face the inner ring raceway surfaces 4a1 which are formed on the outer side of the inner ring members 4a in the axial direction. The outer side in the axial direction refers to the outer side with reference to the inside of the bearing device 2, and corresponds to the left side in FIG. 2. Meanwhile, the inner side in the axial direction refers to the inside or the inner side with reference to the inside of the bearing device 2, and corresponds to the right side in FIG. 2.

The plurality of tapered rollers 5 are disposed between the inner ring raceway surface 4a1 and the outer ring raceway surface 3a1, and between the inner ring raceway surface 4a1 and the outer ring raceway surface 3b1, so as to be rollable. The bearing device 2 according to the present embodiment constitutes a tapered roller bearing in which the plurality of tapered rollers 5 are disposed in four rows. The plurality of tapered rollers 5 are held by the cage 6 in an annular shape in the circumferential direction.

The sealing members 10 seal both ends, in the axial direction, of an annular space formed between the outer ring 3 and the inner ring 4. The sealing members 10 are fixed to respective inner peripheral surfaces 3c of the second outer ring members 3b which constitute the outer ring 3. Grease is supplied to the inside of the bearing device 2 (the annular space which is formed between the outer ring 3 and the inner ring 4), and prevented from leaking to the outside by the sealing members 10. The sealing members 10 also prevent entry of cooling water for cooling the roller of the rolling mill etc. into the bearing device 2. Examples of the grease which is supplied to the inside of the bearing device 2 include Palmax RBG, which is suitable to secure lubrication under high-temperature and high-rotation conditions. Palmax RBG contains a thickener containing amine.

As illustrated in FIG. 2, the sealing member 10 includes an annular core metal 11 and an annular seal body 12 fixed to the core metal 11. The sealing member 10 also includes a spring ring 13. The core metal 11 is made of metal (e.g. SPCC), includes a cylindrical portion 11a and an annular plate portion 11b, and has an L-shape in section. The sealing member 10 is attached to the outer ring 3 with the cylindrical portion 11a of the core metal 11 fitted with the inner peripheral surface 3c of the second outer ring member 3b, which constitutes the outer ring 3, with an outer peripheral portion 12a of the seal body 12 interposed therebetween. The seal body 12 is made of rubber (a crosslinked material of a fluororubber composition), and has a first seal lip 14 that can make sliding contact with an outer peripheral surface 4b of the inner ring member 4a which constitutes the inner ring 4. The seal body 12 further has a second seal lip 15 provided with a gap from the outer peripheral surface 4b of the inner ring member 4a. The seal body 12 is bonded to the core metal 11 through vulcanization adhesion. The spring ring 13 provides the first seal lip 14 with an elastic force in the direction that reduces the diameter.

The seal body 12 which constitutes the sealing member 10 contains uncrosslinked fluororubber, a peroxide crosslinking agent, and an acid acceptor. The seal body 12 is made of a crosslinked material of a fluororubber composition that contains 1 to 5 parts by weight of the acid acceptor with respect to 100 parts by weight of the uncrosslinked fluororubber. Thus, the crosslinked material is a peroxide crosslinked material. As discussed above, in the case where the fluororubber is a peroxide crosslinked material, the progress of a defluoridation reaction upon contact with amine is suppressed compared to a case where the fluororubber is a polyol crosslinked material. Therefore, the progress of a defluoridation reaction due to contact with amine is suppressed even in the case where the sealing member 10 is used in the presence of grease that contains amine such as Palmax RBG, and the seal performance of the sealing member 10 can be maintained over a long period of time.

The uncrosslinked fluororubber to be peroxide crosslinked is not specifically limited. Examples of such uncrosslinked fluororubber include vinylidene fluoride rubber (FKM), ethylene tetrafluoride-propylene rubber (FEPM), and ethylene tetrafluoride-perfluoromethyl vinyl ether rubber (FFKM). Among these, DAI-EL GBR 6002 (manufactured by Daikin Industries, Ltd.) which is FKM and AFLAS 600S (manufactured by Asahi Glass Co., Ltd.) which is FEPM are particularly preferable, since such rubber is particularly unlikely to be subjected to a defluoridation reaction upon contact with amine.

The fluororubber composition contains the peroxide crosslinking agent. The peroxide crosslinking agent is preferably organic peroxide. Examples of the organic peroxide include α,α′-di-(t-butylperoxy) diisopropylbenzene (such as “Perbutyl P (trade name) manufactured by NOF Corporation”, for example) and t-butylperoxybenzoate (such as “Perbutyl Z (trade name) manufactured by NOF Corporation”, for example). The amount of the peroxide crosslinking agent compounded is not specifically limited, and may be determined, as appropriate, in consideration of the combination of the uncrosslinked fluororubber and the peroxide crosslinking agent. Normally, about 1 to 5 parts by weight of the peroxide crosslinking agent is compounded with respect to 100 parts by weight of the uncrosslinked fluororubber.

The fluororubber composition preferably contains a crosslinking aid together with the peroxide crosslinking agent. Examples of the crosslinking aid include multifunctional unsaturated compounds such as triallyl isocyanurate (TAIC) and trimethallyl isocyanurate (TMAIC).

The fluororubber composition contains an acid acceptor. The fluororubber composition contains an acid acceptor, although the fluororubber composition is to be peroxide crosslinked. Therefore, in the case where the seal body is molded using the fluororubber composition, a binding site (e.g. a carbon-carbon double bond) at which the fluororubber may be bound to an adhesive layer may be introduced into the fluororubber. Consequently, the seal body 12 which is made of a crosslinked material of the fluororubber composition can be strongly bonded to the adhesive layer. In addition, a corrosive gas (such as iodine fluoride) can be trapped in the case where such a gas is generated.

Examples of the acid acceptor include calcium oxide, magnesium oxide, lead oxide, zinc oxide, magnesium hydroxide, calcium hydroxide, aluminum hydroxide, and hydrotalcite. These may be used singly, or may be used in combination of two or more thereof. The acid acceptor is preferably zinc oxide.

The amount of the acid acceptor compounded in the fluororubber composition is 1 to 5 parts by weight with respect to 100 parts by weight of the uncrosslinked fluororubber. If the amount of the acid acceptor compounded is less than 1 part by weight, the adhesion between the crosslinked material (seal body) of the fluororubber composition and the adhesive layer is poor. If the amount of the acid acceptor compounded is more than 5 parts by weight, meanwhile, the tensile elongation of the crosslinked material of the fluororubber composition may be reduced, or the water resistance thereof may be degraded. The amount of the acid acceptor compounded is preferably 2.5 to 3.5 parts by weight with respect to 100 parts by weight of the uncrosslinked fluororubber. The fluororubber composition may be compounded with an appropriate amount of a variety of additives such as a processing aid, a reinforcing agent, and a filler.

In the sealing member 10, the seal body 12 is fixed to the core metal 11 via an adhesive layer (not illustrated) provided on the surface of the core metal 11. The adhesive layer is preferably a baked layer of a silane coupling adhesive provided on the surface of the core metal 11. The baked layer is a layer provided by applying a silane coupling adhesive to the surface of the core metal 11 and thereafter heating the silane coupling adhesive.

The silane coupling adhesive may be an adhesive that may adhere to both metal such as SPCC and fluororubber. Specific examples of the slime coupling adhesive include monicas MP-204 (manufactured by Yokohama Kobunshi Kenkyujo Co., Ltd.). The silane coupling adhesive is preferably dilutable in a solvent. This is because such a silane coupling adhesive is easy to handle and easily prevents a die from being soiled.

In the sealing member 10 according to the present embodiment, it is only necessary that the adhesive layer should be provided on at least a portion of the surface of the core metal 11 to which the seal body 12 is to be fixed. The adhesive layer may be provided on the entire surface of the core metal 11, or may be provided on only a portion of the surface of the core metal 11 to which the seal body 12 is to be fixed.

The thus configured sealing member 10 can be manufactured through the following processes (a) to (c), for example. In the process (a), first, a silane coupling adhesive is applied to at least a portion of the surface of the core metal 11 to which the seal body 12 is to be bonded. The silane coupling adhesive may be applied by immersing the core metal 11 in the silane coupling adhesive, applying the silane coupling adhesive to only a predetermined portion of the core metal 11 using a brush, or the like. To that end, the silane coupling adhesive is preferably dilutable in a solvent such as methanol.

In the process (a), next, the silane coupling adhesive is heated together with the core metal 11 to form a baked layer of the silane coupling adhesive on the surface of the core metal 11. The heating temperature is preferably 200° C. or higher. A heating process is performed at 200° C. or higher to form the baked layer. Consequently, the adhesion between the core metal 11 and the seal body 12 in the completed sealing member 10 is particularly high. The upper limit of the preferable heating temperature is 260° C. The heating time in the process (a) is not specifically limited, and may be 10 to 90 minutes, for example.

In the process (b), which is performed separately from the process (a), uncrosslinked fluororubber, a peroxide crosslinking, agent, an acid acceptor, a crosslinking aid and, as necessary, a variety of additives are kneaded by a conventionally known method to prepare a fluororubber composition.

In the process (c), the core metal 11 on which the baked layer of the silane coupling adhesive is provided and which is fabricated in the process (a) and the fluororubber composition which is prepared in the process (b) are put into a die. In the die, the fluororubber composition is molded, and the core metal and a crosslinked material of the fluororubber composition are bonded to each other through vulcanization adhesion. In this event, the molding conditions are not specifically limited, and may be determined, as appropriate, in consideration of the composition of the fluororubber composition etc. The sealing member 10 can be manufactured through such processes.

The adhesion between the core metal and the seal body will be verified below.

1. Verification of Effect of Heating Temperature of Silane Coupling Adhesive on Adhesion

The adhesion between the core metal 11, on the surface of which the adhesive layer was provided, and the seal body 12, which was made of the crosslinked material of the fluororubber composition, was evaluated using a method that conformed to “JIS K 6256-2 (2013)”.

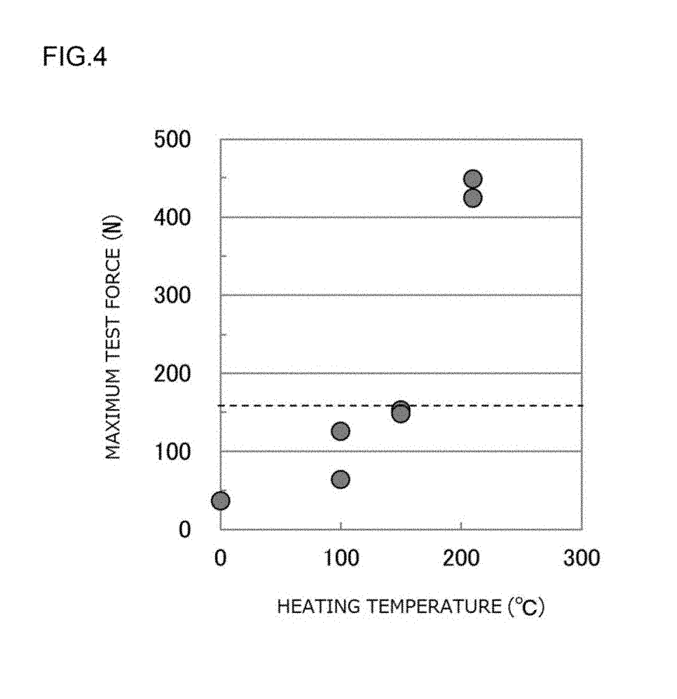

(1) SPCC steel (dull-finished) with dimensions 60 mm×25 mm and a thickness of 2 mm was prepared as a steel plate corresponding to the core metal 11. First, exfoliate paper was pasted to the steel plate except at the center portion (25 mm×25 mm) to expose only the center portion of the steel plate. Next, a stock solution of a silane coupling adhesive “monicas MP-204 (manufactured by Yokohama Kobunshi Kenkyujo Co., Ltd.)”, or a solution thereof diluted twice with methanol, was applied to the exposed center portion of the steel plate. In this event, the silane coupling adhesive was applied using a brush. After that, the steel plate to which the silane coupling adhesive was applied was subjected to a heating process at 100° C., 150° C., or 210° C. for 30 minutes to fabricate a steel plate on which a baked layer of the silane coupling adhesive was provided. In addition, a steel plate which was dried at room temperature (indicated at a heating temperature of 0° C. in FIG. 4), rather than being subjected to the heating process, after application of the silane coupling adhesive was also prepared.

(2) A fluororubber composition (A) was prepared as the fluororubber composition.

Fluororubber composition (A): 1.5 parts by weight of a crosslinking agent (Perbutyl P manufactured by NOF Corporation), 4 parts by weight of a crosslinking aid (TAIC manufactured by Nihon Kasei Co., Ltd.), and 3 parts by weight of an acid acceptor (Zinc Oxide No. 2 manufactured by Sakai Chemical Industry Co., Ltd.) were added to 100 parts by weight of FKM (DAI-EL GBR 6002 manufactured by Daikin Industries, Ltd.), and the mixture was kneaded to prepare a fluororubber composition (A).

(3) The steel plates fabricated in the process (1) and the fluororubber composition (A) prepared in the process (2) were appropriately combined with each other, and put into a dedicated die. Molding was performed using the dedicated die to fabricate a test piece for evaluation in which the steel plate and a crosslinked material of the fluororubber composition were bonded to each other. The molding conditions were 160° C.×10 minutes for primary vulcanization and 200° C.×4 hours fin secondary vulcanization.

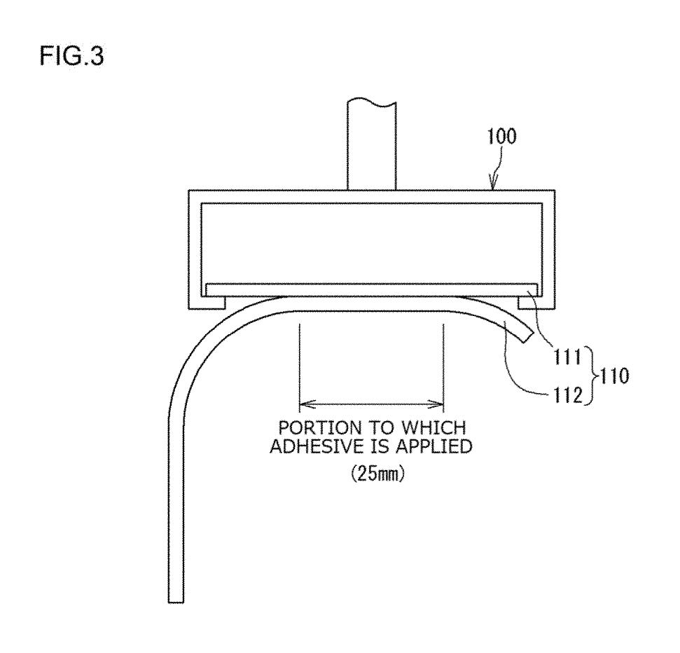

(4) The adhesion between the steel plate and the crosslinked material of the fluororubber composition in each test piece fabricated was measured as a maximum test force (N). FIG. 3 illustrates a method of evaluating the adhesion of a test piece. As illustrated in FIG. 3, a test piece 110 in which a crosslinked material 112 of a fluororubber composition was bonded to a steel plate 111 was supported by a test jig 100. In this state, a test force was recorded while pulling the crosslinked material 112 of the fluororubber composition downward, and the test force at the time when the crosslinked material 112 of the fluororubber composition was completely peeled off from the steel plate 111 was recorded as the maximum test force. The test force was measured using an autograph (not illustrated) to which the test jig 100 was attached. The results are indicated in FIG. 4.

FIG. 4 is a graph indicating the results of evaluation of the adhesion of the test pieces. The graph in FIG. 4 indicates measurement results plotted on the horizontal axis which represents the heating temperature (° C.) at which a baked layer of the silane coupling adhesive was formed and the vertical axis which represents the maximum test force (N). It was revealed from the results indicated in FIG. 4 that the adhesion between the steel plate which was made of SPCC and the crosslinked material of the fluororubber composition was enhanced by providing a baked layer of the silane coupling adhesive at a heating temperature of higher than 200° C.

Further, the state of peel of the crosslinked material 112 of the fluororubber composition was visually observed for test pieces in which the crosslinked material 112 had been completely peeled off from the steel plate 111 (test pieces after the measurement of the maximum test force). As a result, it was revealed that the crosslinked material 112 was broken (break of the base material), rather than the interface between the steel plate 111 and the crosslinked material 112, in test pieces with a maximum test force of 160 N or more, and that the crosslinked material 112 was peeled at the interface between the steel plate 111 and the crosslinked material 112 (break at the interface) in test pieces with a maximum test force of less than 160 N.

2. Verification of Effect of Acid Acceptor on Adhesion

In this verification, a fluororubber composition (B) not containing an acid acceptor and prepared as described below was used. Fluororubber composition (B): 1.5 parts by weight of a crosslinking agent (Perbutyl P manufactured by NOF Corporation) and 4 parts by weight of a crosslinking aid (TAIC manufactured by Nihon Kasei Co., Ltd.) were added to 100 parts by weight of FKM (DAI-EL GBR 6002 manufactured by Daikin industries, Ltd.), and the mixture was kneaded to prepare a fluororubber composition (B). A steel plate obtained by applying a stock solution of monicas MP-204 and drying the solution at room temperature was used as the steel plate on which a silane coupling adhesive layer was provided. In this verification, test pieces were fabricated using the fluororubber composition (B) described above and the steel plate described above by a method that was similar to the method used in the verification in 1. above.

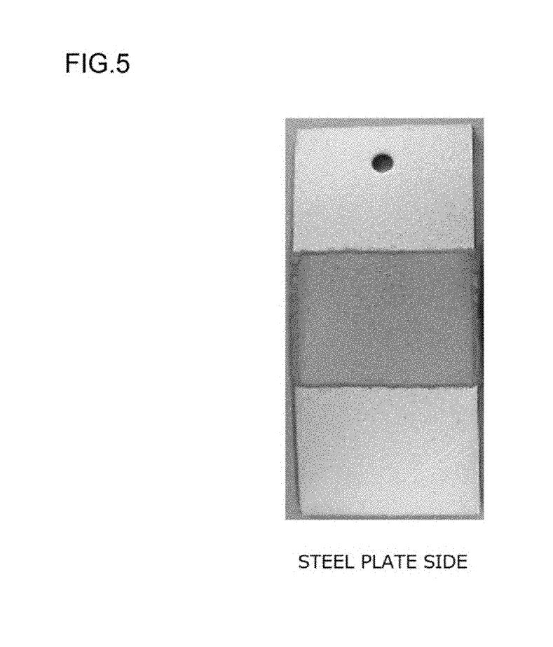

Next, a 90° peel test conforming to JIS K 6256-2 (2013) was performed on the test pieces by a method that was similar to the method used in the verification in 1. above. As a result, it was found that the surface of the steel plate was rusted to reduce the adhesion. FIG. 5 is a photograph illustrating the state of a test piece after evaluation. It can be observed that the surface of the steel plate is rusted. This result revealed that it was difficult to secure sufficient adhesion between a crosslinked material of the fluororubber composition and a steel plate made of SPCC in the case where the fluororubber composition did not contain an acid acceptor.

The sealing member according to the embodiment of the present invention is not limited to a sealing member that seals a bearing device for use at roll necks of rolling mills. The sealing member is suitably usable as a sealing member for use in the presence of grease that contains amine, and in particular as a sealing member for use in the presence of grease that contains amine and under high-temperature conditions. Thus, the sealing member is also suitably usable for bearings for automobiles etc.

With the sealing member and the method of manufacturing the same according to the present invention, it is possible to provide a sealing member that includes a core metal and a seal body, that adopts peroxide crosslinked fluororubber as the material of the seal body, that secures sufficient adhesion between the core metal and the seal body, that is not easily degraded even when used in the presence of grease that contains amine, and that maintains its seal performance over a long period. Therefore, in a bearing device that includes the sealing member, the frequency of replacement of the sealing member can be lowered, and thus the maintenance cost can be reduced.

What is claimed is:

1. A sealing member comprising:
an annular core metal; and
an annular seal body fixed to the core metal and having a lip portion, wherein:
the seal body is made of a crosslinked material of a fluororubber composition that contains uncrosslinked fluororubber, a peroxide crosslinking agent, and an acid acceptor, the crosslinked material of the fluororubber composition containing 1 to 5 parts by weight of the acid acceptor with respect to 100 parts by weight of the uncrosslinked fluororubber; and
the seal body is fixed to the core metal via an adhesive layer provided on a surface of the core metal.

2. The sealing member according to claim 1, wherein
the acid acceptor is zinc oxide.

3. The sealing member according to claim 1, wherein
the adhesive layer is a baked layer of a silane coupling adhesive.

4. A method of manufacturing the sealing member according to claim 3, the method comprising:
a step (a) of forming a baked layer of a silane coupling adhesive on a core metal by applying the silane coupling adhesive to at least a portion of a surface of the core metal to which the seal body is to be bonded and thereafter performing a heating process on the portion;
a step (b) of preparing a fluororubber composition by kneading at least an uncrosslinked fluororubber, a peroxide crosslinking agent, and an acid acceptor; and
a step (c) of putting the core metal which has been subjected to the step (a) and the fluororubber composition which is prepared in the step (b) into a die, molding the fluororubber composition in the die, and bonding the core metal and a crosslinked material of the fluororubber composition to each other through vulcanization adhesion.

5. The method of manufacturing a seating member according to claim 4, wherein
a heating temperature in the step (a) is 200° C. or higher.
